(19) United States
(12) Patent Application Publication
(10) Pub. No.: US 2008/0240273 A1
(43) Pub. Date: Oct. 2, 2008

(54) RADIO TRANSMITTING APPARATUS AND RADIO RECEIVING APPARATUS USING OFDM

(76) Inventor: Koji AKITA, Yokohama-shi (JP)

Correspondence Address: OBLON, SPIVAK, MCCLELLAND MAIER & NEUSTADT, P.C., 1940 DUKE STREET, ALEXANDRIA, VA, 22314, US

(21) Appl. No.: 12/049,826

(22) Filed: Mar. 17, 2008

(30) Foreign Application Priority Data
Mar. 28, 2007 (JP) 2007-085700

(51) Int. Cl. H04L 27/28

(52) U.S. Cl. 375/260

(57) ABSTRACT

A radio transmitting apparatus includes an attacher to attach an error-detecting bit to a bit sequence, a coder to perform systematic coding on a bit sequence to which the error-detecting bit is attached to generate an information bit sequence and a parity bit sequence, a first modulator to modulate the information bit sequence to generate a first modulation symbol, a second modulator to modulate the parity bit sequence to generate a second modulation symbol, an allocator to allocate the first modulation symbols to first subcarriers by dispersing the first modulation symbols in the frequency/time direction, and allocate the second modulation symbols to second subcarriers different from the first subcarriers, an modulator to perform OFDM modulation on the first and second modulation symbols by using the first and the second subcarriers to generate an OFDM signal, and a transmitting unit to transmit the OFDM signal.

### CROSS-REFERENCE TO RELATED APPLICATIONS

This application is based upon and claims the benefit of priority from prior Japanese Patent Application No. 2007-085700, filed Mar. 28, 2007, the entire contents of which are incorporated herein by reference.

### BACKGROUND OF THE INVENTION

1. Field of the Invention

The present invention relates to a radio transmitting apparatus and a radio receiving apparatus using orthogonal frequency division multiplexing (OFDM).

2. Description of the Related Art

In radio communication, a signal that is transmitted may receive various types of distortion on the propagation path, and hence an estimation (channel estimation) of the distortion received by the signal on the propagation path, and compensation (which is called channel equalization) for the distortion of the received signal using the channel estimation value become necessary on the receiving side. As a simple method for performing channel estimation, a method of transmitting a signal called a pilot signal, and known to both the transmitting side and the receiving side, is widely known. Channel estimation can be performed by comparing a known signal corresponding to the pilot signal and the received signal with each other on the receiving side.

As a method other than the method using the pilot signal, decision feedback equalization (DFE) is known. DFE is a method in which an unknown signal sequence is subjected to determination processing on the receiving side, and channel estimation is performed on the basis of the determination result. According to DFE, when correct determination is performed, channel estimation equal to that performed by using a pilot signal can be performed. However, there is a problem that when incorrect determination is performed in DFE, the channel estimation also becomes incorrect, and hence the receiving characteristic is deteriorated.

As countermeasures against the above problem, a method in which an error-detecting bit such as a parity bit, and cyclic redundancy check (CRC) is attached to the signal sequence, a method in which a signal sequence is encoded, and the like are known. By attaching an error-detecting bit to the signal sequence, it is possible to detect that the determination result is incorrect, and hence it is possible to prevent incorrect channel estimation. When the signal sequence is encoded, a gain can be obtained, and the probability of the determination result becoming incorrect is therefore reduced.

The DFE process to be performed when the transmission signal is produced by attaching an error-detecting bit to the signal sequence, encoding and modulating the signal sequence will be described below. On the receiving side, demodulation and decoding of the received signal is performed, and an error is detected by using the error-detecting bit. When it can be confirmed by the error-detecting bit that there is no error, the bit sequence obtained by the decoding is encoded and modulated again. This makes it possible to restore a modulation symbol transmitted from the transmitting side to its original state, and perform a channel estimation by using the restored modulation symbol as a reference. In order to perform such a DFE process on the receiving side, re-encoding of the bit sequence is required, and hence there is a problem of an increase in the circuit size necessary for the re-encoding, and an occurrence of a processing delay.

As to the problem described above, a solution particularly for the problem of a case where a coding scheme classified as a systematic encoding is employed is shown in JP-A 2004-153640 (KOKAI) and JP-A 2004-187257 (KOKAI). In systematic encoding, two types of bit sequences, including the same information bit sequence as the bit sequence input to the encoder, and an encoded parity bit sequence, are output from the encoder. In JP-A 2004-153640 (KOKAI) and JP-A 2004-187257 (KOKAI), the information bit sequence and the parity bit sequence are separately modulated in different modulators. Accordingly, as for a modulation symbol to which only an information bit sequence is allocated, a reference signal can be produced without the need for re-encoding processing. That is, when, of all the received signals, only modulation symbols to which information bit sequences are allocated are used as references, the DFE process can be performed without the need for the re-encoding processing.

In JP-A 2004-153640 (KOKAI), nothing is disclosed as to how to allocate a modulation symbol to which only an information bit sequence is allocated to a subcarrier.

On the other hand, in JP-A 2004-187257 (KOKAI), a modulation symbol to which only an information bit sequence is allocated is allocated to a subcarrier (subcarrier in the vicinity of a center of a frequency band) in the vicinity of a center frequency. When such allocation is performed, a channel estimation can be performed only in a frequency band in the vicinity of a center of a frequency band. As a result, an accurate channel estimation cannot be performed as a whole in the entire band, and the receiving characteristic is deteriorated.

Furthermore, if a modulation symbol is allocated to a subcarrier by the method shown in JP-A 2004-153640 (KOKAI) and JP-A 2004-187257 (KOKAI), interleaving of the bit sequence is not sufficiently performed, and the resistance to a burst error is therefore deteriorated.

### BRIEF SUMMARY OF THE INVENTION

According to one aspect of the present invention, there is provided a radio transmitting apparatus comprising: an attacher to attach an error-detecting bit to a first bit sequence to be transmitted to produce a second bit sequence; a coder to perform systematic coding on the second bit sequence to generate an information bit sequence and a parity bit sequence; a first modulator to modulate the information bit sequence to generate a first modulation symbol; a second modulator to modulate the parity bit sequence to generate a second modulation symbol; an allocator configured to allocate the first modulation symbols to a plurality of first subcarriers by dispersing the first modulation symbols in at least one of the frequency direction and the time direction modulation symbol, and allocate the second modulation symbols to a plurality of second subcarriers different from the first subcarriers; an OFDM modulator to perform orthogonal frequency division multiplexing (OFDM) modulation on the first modulation symbol and the second modulation symbol by using the first subcarriers and the second subcarriers to generate an OFDM signal; and a transmitting unit configured to transmit the OFDM signal.

### BRIEF DESCRIPTION OF THE SEVERAL VIEWS OF THE DRAWING

FIG. 1 is a block diagram showing a radio transmitting apparatus according to a first embodiment.

FIG. 2 is a block diagram showing a systematic encoder.

FIG. 3 is a block diagram showing a radio receiving apparatus according to the first embodiment.

FIG. 4 is a block diagram showing a modification example of the radio transmitting apparatus according to the first embodiment.

FIG. 5 is a view showing an example of subcarrier allocation in the first embodiment.

FIG. 6 is a view showing an example of subcarrier allocation in the first embodiment.

FIG. 7 is a view showing an example of subcarrier allocation in the first embodiment.

FIG. 8 is a view showing an example of subcarrier allocation in the first embodiment.

FIG. 9 is a view showing an example of subcarrier allocation in the first embodiment.

FIG. 10 is a view showing an example of subcarrier allocation in the first embodiment.

FIG. 11 is a view showing an example of subcarrier allocation in the first embodiment.

FIG. 12 is a view showing an example of subcarrier allocation in the first embodiment.

FIG. 13 is a view showing an example of subcarrier allocation in the first embodiment.

FIG. 14 is a view showing an example of subcarrier allocation in the first embodiment.

FIG. 15 is a block diagram showing a radio transmitting apparatus according to a second embodiment.

FIG. 16 is a block diagram showing a radio receiving apparatus according to the second embodiment.

FIG. 17 is a block diagram showing a modification example of the radio transmitting apparatus according to the second embodiment.

FIG. 18 is a view showing an example of subcarrier allocation in the second embodiment.

FIG. 19 is a view showing an example of subcarrier allocation in the second embodiment.

FIG. 20 is a view showing an example of subcarrier allocation in the second embodiment.

FIG. 21 is a view showing an example of subcarrier allocation in the second embodiment.

FIG. 22 is a view showing an example of subcarrier allocation in the second embodiment.

FIG. 23 is a block diagram showing a radio transmitting apparatus according to a third embodiment.

FIG. 24 is a block diagram showing a radio receiving apparatus according to the third embodiment.

FIG. 25 is a block diagram showing a modification example of the radio transmitting apparatus according to the third embodiment.

FIG. 26 is a view showing an example of subcarrier allocation in the third embodiment.

FIG. 27 is a view showing an example of subcarrier allocation in the third embodiment.

FIG. 28 is a view showing an example of subcarrier allocation in the third embodiment.

FIG. 29 is a view showing an example of subcarrier allocation in the third embodiment.

FIG. 30 is a view showing an example of subcarrier allocation in the third embodiment.

FIG. 31 is a view showing an example of subcarrier allocation in the third embodiment.

### DETAILED DESCRIPTION OF THE INVENTION

### First Embodiment

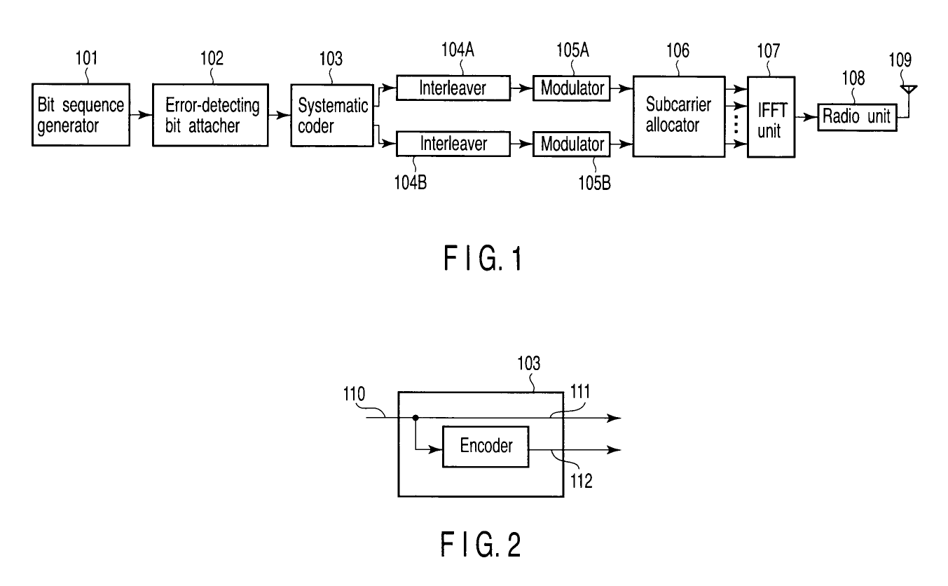

A first embodiment of the present invention will be described below with reference to FIGS. 1 to 14.

### <Radio Transmitting Apparatus>

As shown in FIG. 1, in a radio transmitting apparatus according to the first embodiment, a bit sequence to be transmitted is generated by a bit sequence generator 101. This bit sequence is used in, for example, a common control channel (CCCH). This bit sequence is, after an error-detecting bit is attached thereto by an error-detecting bit attacher 102, input to a systematic encoder 103.

In the systematic encoder 103, a bit sequence 110 input thereto is branched into two parts as shown in FIG. 2. One of the branched parts of the bit sequence is output as it is. The input bit sequence 110 which is output from the systematic encoder 103 as it is as a bit sequence 111 as described above is called an information bit sequence. The other of the branched parts of the bit sequence is encoded by the systematic encoder 103, and is output therefrom. The encoded bit sequence 112 is called a parity bit sequence.

Here, the ratio of a length (bit count) of the input bit sequence 110 to a sum of a length (bit count) of the information bit sequence 111 and a length (bit count) of the parity bit sequence 112 which are output from the systematic encoder 103 is called a coding rate. For example, when the coding rate is 1/3, an information bit sequence 111 of 10 bits and a parity bit 112 of 20 bits are output with respect to an input bit sequence 110 of 10 bits. Further, for example, when the coding rate is 2/3, an information bit sequence 111 of 10 bits and a parity bit sequence 112 of 5 bits are output with respect to an input bit sequence 110 of 10 bits.

In general, when the coding rate is R, an information bit sequence 111 of N bits and a parity bit sequence 112 of (1/R−1)×N bits are output with respect to an input bit sequence 110 of N bits. That is, the ratio in length of the information bit sequence 111 to the parity bit sequence 112 is expressed as 1:(1/R−1).

The information bit sequence 111 and the parity bit sequence 112 which are output from the systematic encoder 103 are subjected to interleaving by interleavers 104A and 104B, respectively, and thereafter modulated by modulators 105A and 105B, respectively, thereby generating a first modulation symbol and a second modulation symbol, respectively. In the modulators 105A and 105B, various digital modulation schemes known in the prior art, such as binary phase shift keying (BPSK), quadrature phase shift keying (QPSK), amplitude shift keying (ASK), frequency shift keying (FSK), 16 quadrature amplitude modulation (16QAM), 64QAM, and the like are utilized. The first and second modulation symbols generated by the modulators 105A and 105B are input to a subcarrier allocator 106 so as to be subjected to OFDM modulation.

In the subcarrier allocator 106, the first modulation symbols are allocated to first subcarriers of all the subcarriers allocated to the information bit sequences so as to be uniformly dispersed in at least one of a frequency direction and a time direction, and the second modulation symbols are allocated to second subcarriers to which the first modulation symbols are not allocated, the second subcarriers being other than the first subcarriers to which the first modulation symbols are allocated. In other words, the first modulation symbols are allocated to a plurality of first subcarriers dispersed in at least one of the frequency direction and the time direction. Specific examples of such subcarrier allocation will be described later in detail.

The signal that has been subjected to the subcarrier allocation by the subcarrier allocator 106 in the manner described above is converted from a signal in the frequency domain into a signal in the time domain by being subjected to inverse fast Fourier transform (IFFT) by an IFFT unit 107 used as an OFDM modulator. In the IFFT unit 107, the OFDM modulation is performed, and an OFDM signal is generated in the manner described above. The OFDM signal is subjected to digital-to-analog conversion in a radio unit 108, and upconverted into a signal of a frequency in the RF (radio frequency) band serving as a transmission RF signal. The transmission RF signal is power-amplified, and is thereafter supplied to a transmitting antenna 109 so as to be transmitted.

### <Radio Receiving Apparatus>

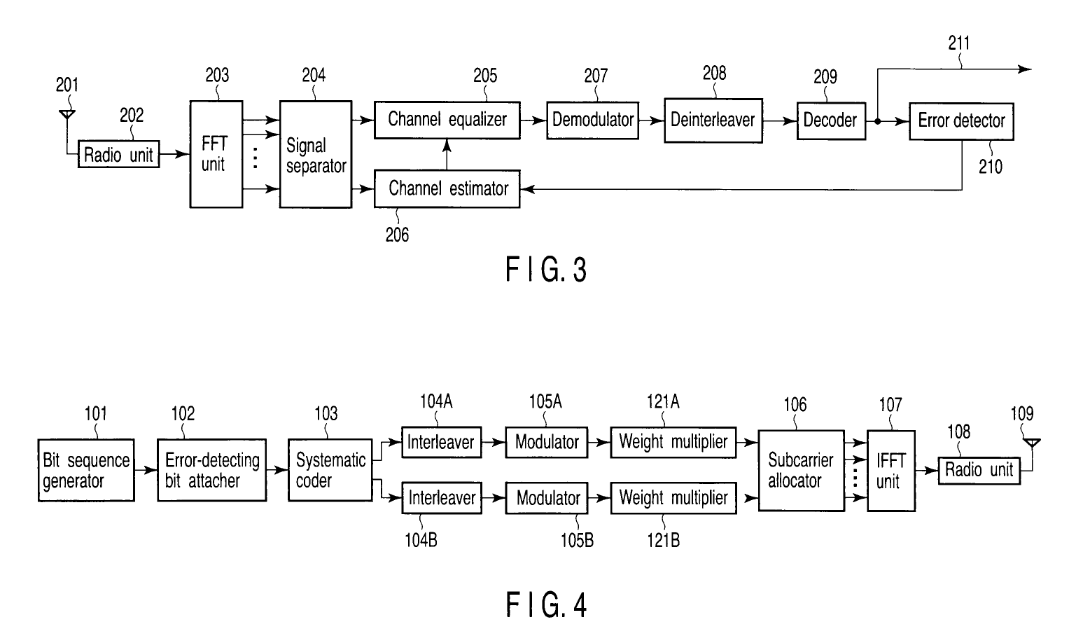

FIG. 3 shows a radio receiving apparatus corresponding to the radio transmitting apparatus shown in FIG. 1. A transmission RF signal from the radio transmitting apparatus is received by a receiving antenna 201, and a reception RF signal is output from the receiving antenna 201. The reception RF signal is amplified, downconverted, and subjected to analog-to-digital conversion in a radio unit 202, whereby an OFDM signal which is a baseband digital signal is generated.

The OFDM signal output from the radio unit 202 is subjected to fast Fourier transform (FFT) in an FFT unit 203 which is used as an OFDM demodulator, whereby the signal is separated into signals for each subcarrier. A first modulation symbol and a second modulation simbol are separated from the signals for each subcarrier output from the FFT unit 203 by a signal separator 204. The first modulation symbol and the second modulation symbol are input to a channel equalizer 205, and the first modulation symbol is further input to a channel estimator 206.

In the channel estimator 206, a channel estimation (that is, an estimation of a channel response from the radio transmitting apparatus shown in FIG. 1 to the radio receiving apparatus shown in FIG. 3) is performed by using the first modulation symbol, and a channel estimate is obtained. In the channel equalizer 205, the first modulation symbol and the second modulation symbol are subjected to channel equalization by using the channel estimate obtained by the channel estimator 206.

An equalized signal (the first modulation signal or the second modulation signal after being subjected to channel equalization) output from the channel equalizer 205 is subjected to demodulation corresponding to the modulators 105A and 105B shown in FIG. 1 by a demodulator 207, and a demodulated signal is obtained. The demodulated signal output from the demodulator 207 is subjected to deinterleaving by a deinterleaver 208, and is thereafter input to a decoder 209. In the decoder 209, decoding corresponding to the systematic encoder 103 shown in FIG. 1 is performed. In the decoder 209, the information bit sequence is rerestored, and a reproduced bit sequence, i.e., a reproduced signal 211 is output therefrom.

The parity bit sequence included in the bit sequence reproduced by the decoder 209 is also input to an error detector 210. In the error detector 210, error detection is performed by using the parity bit sequence. An error detection result is supplied to the channel estimator 206. In the channel estimator 206, when no error is detected in the error detector 210, a channel estimation is performed by using the first modulation symbol, and a channel estimate is supplied to the channel equalizer 205.

As described above, according to the first embodiment, the first modulation symbols corresponding to the information bit sequences are allocated to the first subcarriers so as to be uniformly dispersed in at least one of the frequency direction and the time direction, and hence, when DFE is performed in the receiving apparatus without performing re-encoding, a channel estimation of high accuracy can be performed. Further, even when a burst error occurs, the burst error has practically no influence. Furthermore, in the first embodiment, the randomness of the interleaving is improved as compared with the case of JP-A 2004-187257 (KOKAI) where the first modulation symbols are collectively mapped in the vicinity of the center of the frequency band, and hence the receiving performance is improved by the diversity effect.

In the first embodiment, as shown in FIG. 4, weight multipliers 121A and 121B may be inserted between each of the modulators 105A and 105B and the subcarrier allocator 106. In this case, an absolute value of a weighting factor to be multiplied by the weight multiplier 121A is made larger than an absolute value of a weighting factor to be multiplied by the weight multiplier 121B. In other words, the absolute value of the weighting factor to be multiplied by the weight multiplier 121B is made smaller than the absolute value of the weighting factor to be multiplied by the weight multiplier 121A. As a result, a signal to noise ratio (SNR) of the first modulation symbol becomes relatively high as compared with the second modulation symbol, and hence it is possible to improve the accuracy of the channel estimation performed in the channel estimator 206 by using the first modulation symbol.

### Examples of Subcarrier Allocation in the First Embodiment

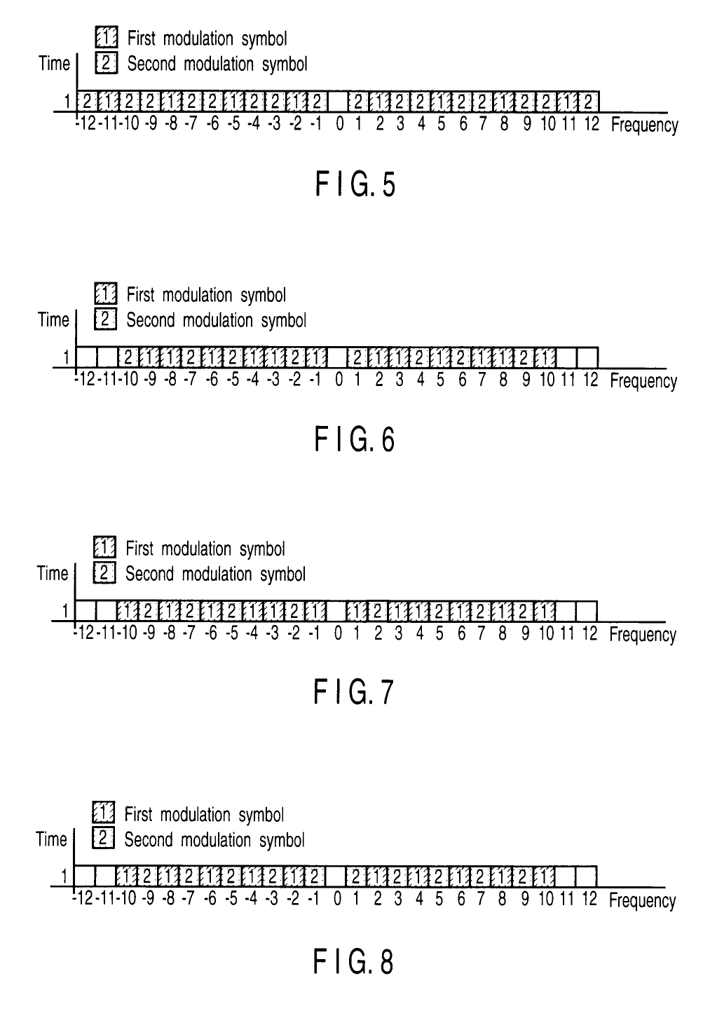

Examples of subcarrier allocation performed in the subcarrier allocator 106 in the first embodiment will be described below by using FIGS. 5 to 14. In the first embodiment, the first modulation symbols are uniformly dispersed in the frequency direction and/or the time axis direction so as to be allocated to the first subcarriers, whereby the accuracy of the channel estimation is improved. In FIGS. 5 to 14, examples of subcarrier allocation are shown in which the abscissa is made the frequency axis, and the ordinate is made the time axis.

In FIGS. 5 to 8, examples of subcarrier allocation of the case where the subcarriers to be allocated to the information bit sequence are limited to one OFDM symbol are shown. FIG. 5 shows an example of the case where the coding rate is 1/3 and first modulation symbols are allocated to first subcarriers arranged in every third place (subcarriers dispersed in the frequency direction), whereby it is possible to uniformly disperse the first modulation symbols. In other words, the first modulation symbols are allocated to the first subcarriers arranged at regular intervals in the frequency direction. This improves the estimation accuracy with respect to the channel variation in the frequency direction.

FIGS. 6 and 7 show examples of the case where the coding rate is 3/5. When the coding rate is 3/5, the ratio in length of the information bit sequence to the parity bit sequence is 1:(5/3−1)=3:2. When the modulators 105A and 105B employ the same modulation scheme, the ratio in length of the first modulation symbol to the second modulation symbol also becomes 3:2. Accordingly, although it is not possible to arrange the first modulation symbols at perfectly regular intervals in the frequency direction like in FIGS. 6 and 7, it is possible to arrange the first modulation symbols so as to uniformly disperse them in terms of the entire frequency band.

As described above, there are cases where the first modulation symbols cannot be allocated to the subcarriers at perfectly regular intervals, depending on the ratio of the first modulation symbol to the second modulation symbol. In such a case, it is advisable to allocate the first modulation symbols to the first subcarriers so as to uniformly disperse them in terms of the entire frequency band. Furthermore, even when it is possible to allocate the first modulation symbols to the first subcarriers at perfectly regular intervals, the intervals may be partly replaced with different intervals.

In the case where the modulators 105A and 105B may employ different modulation schemes, it is possible to adjust the ratio of the first modulation symbols to the second modulation symbols. For example, in an example of a case where the coding rate is 2/5, the ratio of the information bits to the parity bits is 2:(5/2−1)=2:3. When the modulator 105A performs 16QAM modulation, and the modulator 105B performs 64QAM modulation, the numbers of bits per modulation symbol are 4 bits and 6 bits, respectively, and hence the ratio of the first modulation symbols to the second modulation symbols is 1:1. As a result, it is possible to disperse the first modulation symbols at regular intervals in the frequency direction so as to allocate them to the first subcarriers as shown in FIG. 8.

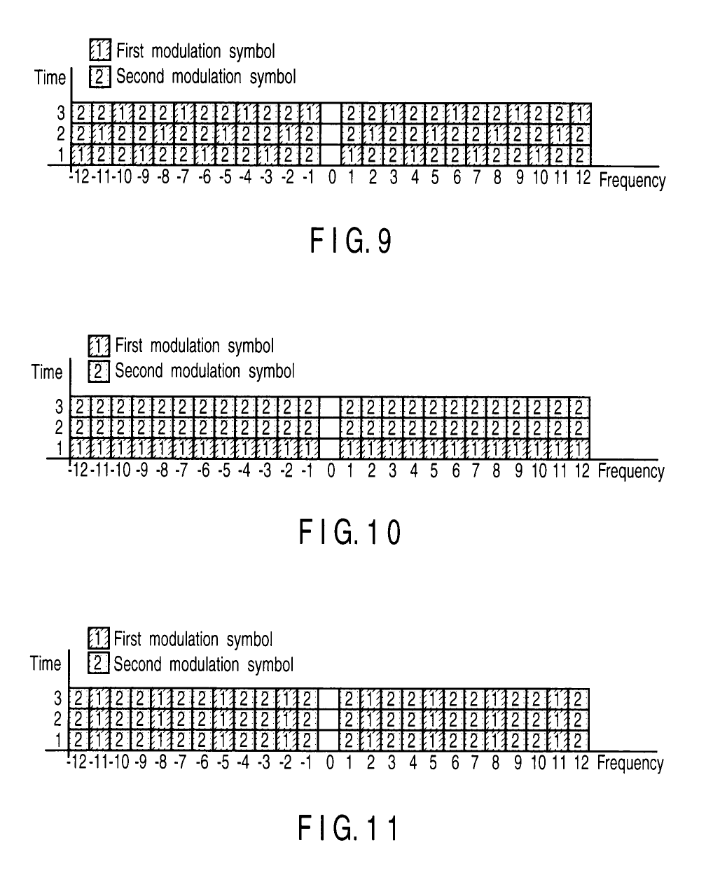

FIGS. 9 to 14 show examples of subcarrier allocation of a case where subcarriers allocated to an information bit sequence span a plurality of OFDM symbols. FIG. 9 shows a case where the coding rate is 1/3. When the first modulation symbols are uniformly dispersed in the frequency direction and the time direction so as to be allocated to the first subcarriers as shown in FIG. 9, it is possible to perform a channel estimation of high accuracy in both the frequency direction and the time direction.

When the channel fluctuation in the frequency direction is large as compared with the channel fluctuation in the time direction, the allocation shown in FIG. 10 is used, and when the channel fluctuation in the time direction is large as compared with the channel fluctuation in the frequency direction, the allocation shown in FIG. 11 is used, and when there is no considerable difference in the channel fluctuation between the frequency direction and the time direction, the allocation shown in FIG. 9 is used. As a result, a channel estimation excellent in accuracy can be performed.

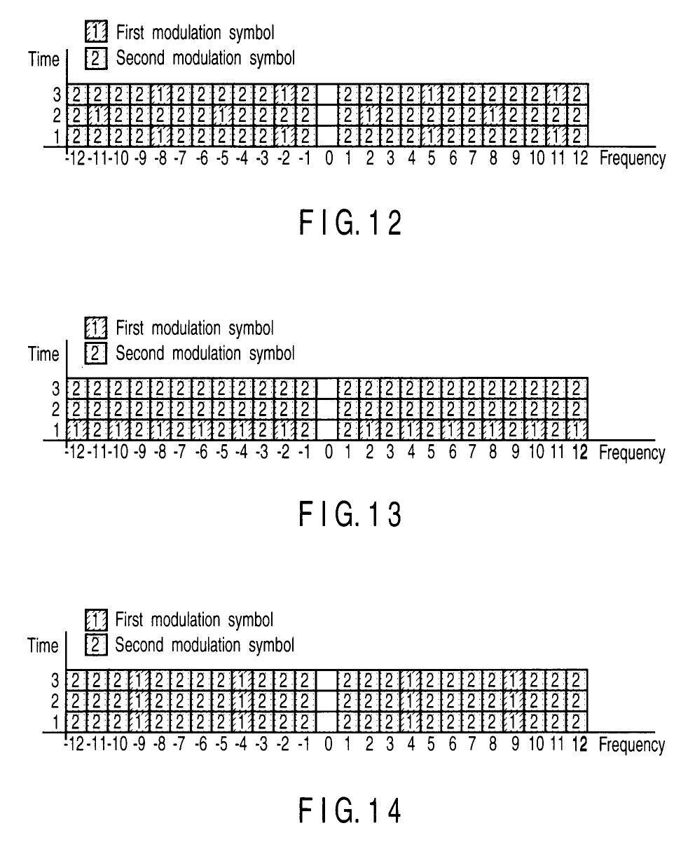

FIGS. 12 to 14 show examples of the case where the coding rate is 1/6. When the first modulation symbols are uniformly dispersed in the frequency direction and the time direction so as to be allocated to the first subcarriers as shown in FIG. 12, it is possible to perform a channel estimation of high accuracy in both the frequency direction and the time direction. Like the example shown in FIG. 9, when the channel fluctuation in the frequency direction is large as compared with the channel fluctuation in the time direction, the allocation shown in FIG. 13 is used, and when the channel fluctuation in the time direction is large as compared with the channel fluctuation in the frequency direction, the allocation shown in FIG. 14 is used, and when there is no considerable difference in the channel fluctuation between the frequency direction and the time direction, the allocation shown in FIG. 12 is used. As a result, a channel estimation excellent in accuracy can be performed.

### Second Embodiment

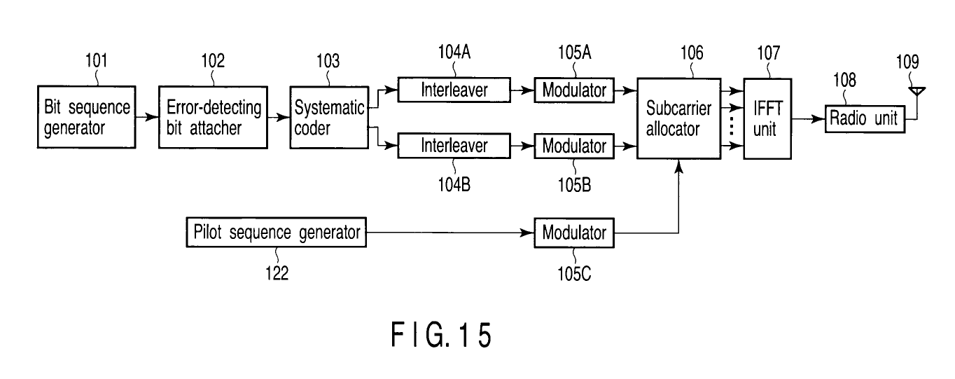

A second embodiment of the present invention will be described below with reference to FIGS. 15 to 22.

### <Radio Transmitting Apparatus>

As shown in FIG. 15, in a radio transmitting apparatus according to the second embodiment, a pilot sequence generator 122 and a modulator 105C are added to the radio transmitting apparatus according to the first embodiment shown in FIG. 1. In the pilot sequence generator 122, a pilot sequence for the channel estimation is generated. The pilot sequence is modulated by the modulator 105C, and a third modulation symbol is produced. Like in the modulators 105A and 105B, various digital modulation schemes known in the prior art, such as BPSK, QPSK, FSK, 16QAM, 64QAM, and the like are utilized in the modulator 105C.

The third modulation symbol is input to a subcarrier allocator 106, and is allocated to the third subcarrier allocated to the pilot sequence. In this case, first modulation symbols output from a modulator 105A are, together with the third modulation symbols, uniformly dispersed in at least one of the frequency direction and the time direction so as to be allocated to the first subcarriers. Second modulation symbols output from a modulator 105B are allocated to the second subcarriers of the subcarriers allocated to the information bit sequences to which the first modulation symbols are not allocated.

A signal that has been subjected to subcarrier allocation in the subcarrier allocator 106 is then subjected to OFDM modulation in the IFFT unit 107, and an OFDM signal is produced. The OFDM signal is upconverted in a radio unit 108 into a signal of a frequency in the RF band serving as a transmission RF signal. The transmission RF signal is further power-amplified, and is thereafter supplied to a transmitting antenna 109 so as to be transmitted.

### <Radio Receiving Apparatus>

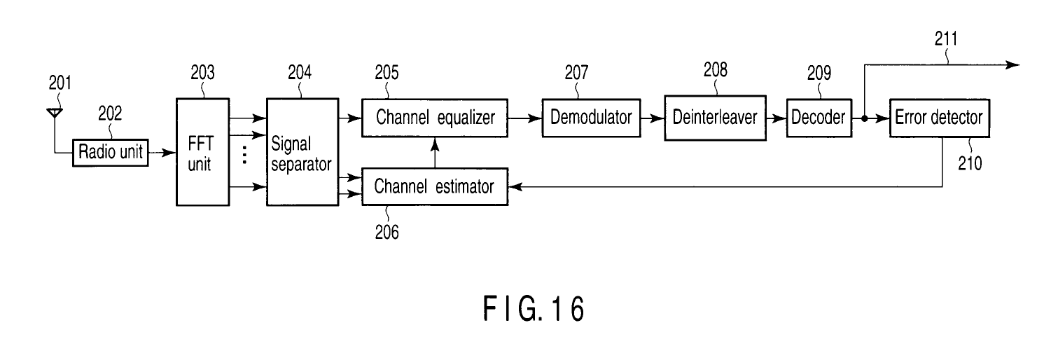

FIG. 16 shows a radio receiving apparatus corresponding to the radio transmitting apparatus shown in FIG. 15. When compared with the radio receiving apparatus according to the first embodiment shown in FIG. 3, the radio receiving apparatus according to the second embodiment differs from the radio receiving apparatus according to the first embodiment in the point that the first modulation symbol, second modulation symbol, and third modulation symbol are separated from a signal for each subcarrier output from an FFT unit 203 by a signal separator 204, and the third modulation symbol is input to a channel estimator 206 in addition to the first modulation symbol. In the channel estimator 206, when no error is detected, a channel estimation is performed by using the first modulation symbol and the third modulation symbol, and a channel estimate is supplied to a channel equalizer 205.

As described above, according to the second embodiment, the first modulation symbols corresponding to the information bit sequence are dispersed in the frequency direction so as to be allocated to the first subcarriers, and the third modulation symbols corresponding to the pilot sequence and can be used in the channel estimation irrespective of the error detection result and are uniformly dispersed in at least one of the frequency direction and the time direction so as to be allocated to the third subcarriers. As a result, when DFE is performed in the receiving apparatus without performing re-encoding, a channel estimation of further higher accuracy can be performed. Further, even when a burst error occurs, the burst error has practically no influence, and the randomness of the interleaving is improved, whereby the receiving performance is improved by the diversity effect, which is the same as the first embodiment.

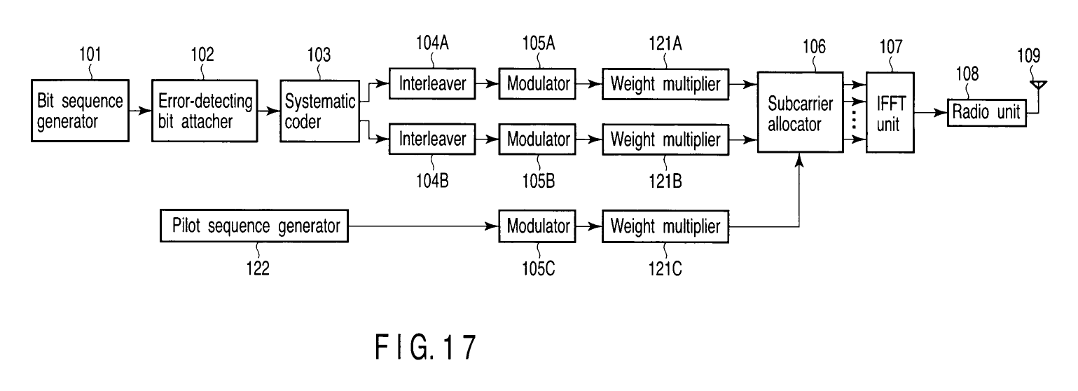

In the second embodiment too, weight multipliers 121A, 121B, and 121C may be inserted between each of the modulators 105A, 105B, and 105C and the subcarrier allocator 106 as shown in FIG. 17. In this case, when an absolute value of a weighting factor to be multiplied by the weight multiplier 121A, and an absolute value of a weighting factor to be multiplied by the weight multiplier 121C are made larger than an absolute value of a weighting factor to be multiplied by the weight multiplier 121B, SNRs of the first modulation symbol and the third modulation symbol become relatively high as compared with the second modulation symbol, and hence it is possible to more effectively improve the accuracy of the channel estimation performed by using the first modulation symbol and the third modulation symbol.

### Examples of Subcarrier Allocation in the Second Embodiment

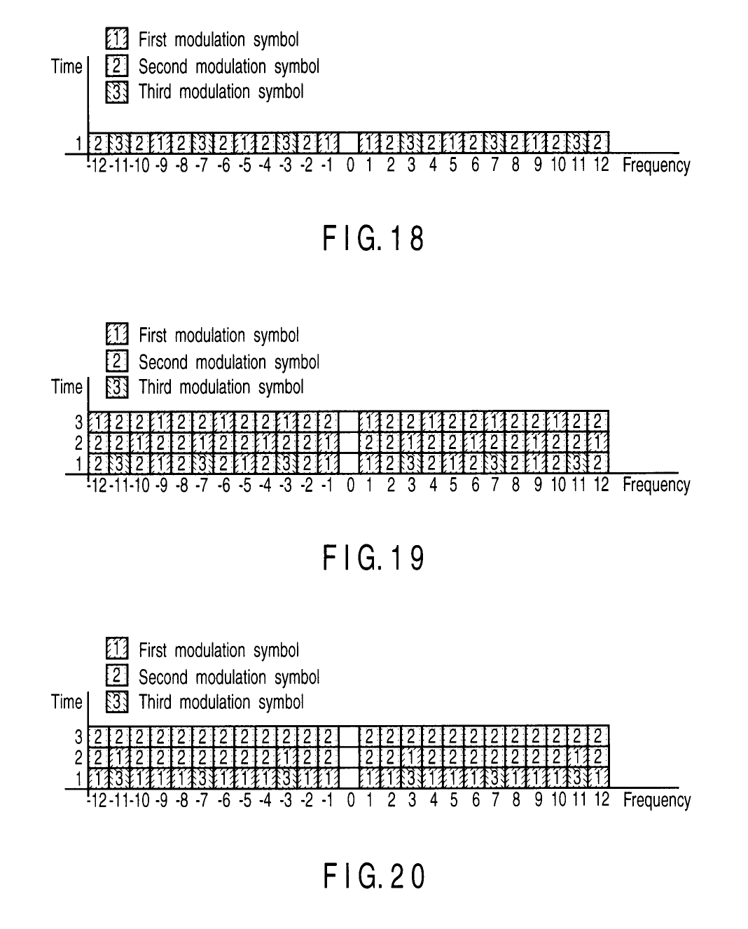

Examples of subcarrier allocation performed in the subcarrier allocator 106 in the second embodiment will be described below by using FIGS. 18 to 21. In the second embodiment, the first modulation symbols and the third modulation symbols are uniformly dispersed in the frequency direction and/or the time direction so as to be allocated to the first subcarriers and the third subcarriers, whereby the accuraccy of the channel estimation is improved. In FIGS. 18 to 21, examples of subcarrier allocation are shown in which the abscissa is made the frequency axis, and the ordinate is made the time axis, like in FIGS. 5 to 14.

FIG. 18 shows an example of subcarrier allocation of the case where the subcarriers to be allocated to the information bit sequence are limited to one OFDM symbol, and the coding rate is 1/3. In the example shown in FIG. 18, the third modulation symbols are arranged at regular first periods (in the example in FIG. 18, periods each corresponding to four subcarriers) in the frequency direction. The first modulation symbols are also arranged at the first periods, and are arranged at positions shifted from those of the third modulation symbols by half the first period (in the example in FIG. 18, an amount corresponding to two subcarriers) in the frequency direction.

When the first modulation symbols and the third modulation symbols are respectively allocated to the first subcarriers and the third subcarriers in the manner described above, both the first modulation symbols and the third modulation symbols are uniformly dispersed in the frequency direction, whereby it is possible to perform channel estimation of higher accuracy by using the first modulation symbols and the third modulation symbols.

Further, in the allocation shown in FIG. 18, the modulation symbols are arranged so as to be uniformly dispersed in the frequency direction even in terms of only the third modulation symbols, and hence when an error is detected in the information bit sequence, even if the channel estimation is performed by using only the third modulation symbols, it is possible to perform channel estimation of high accuracy.

FIGS. 19 to 22 show examples of subcarrier allocation of a case where subcarriers allocated to the information bit sequence span a plurality of OFDM symbols. When the first modulation symbols and the third modulation symbols are uniformly dispersed in both the frequency direction and the time direction so as to be respectively allocated to the subcarriers as shown in FIG. 19, it is possible to perform channel estimation excellent in accuracy in both the time direction and the frequency direction.

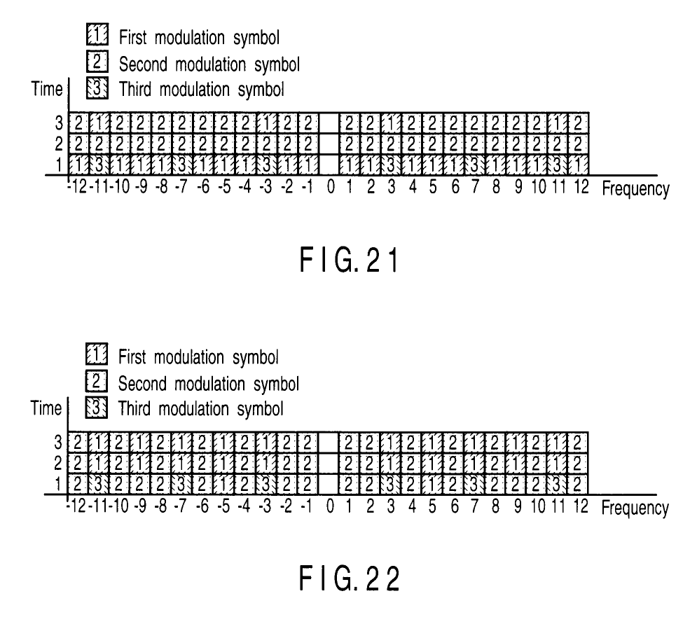

When the first modulation symbols and the third modulation symbols are uniformly dispersed in the frequency direction so as to be respectively allocated to the subcarriers as shown in FIG. 20 or 21, it is possible to perform channel estimation excellent in accuracy in the frequency direction.

When the first modulation symbols and the third modulation symbols are uniformly dispersed in the time direction so as to be respectively allocated to the subcarriers as shown in FIG. 22, it is possible to perform channel estimation excellent in accuracy in the time direction.

FIGS. 20 and 21 differ from each other in the time position at which the first modulation symbols are allocated to the frequency positions to which the third modulation symbols are allocated. In general, the first modulation symbol of an information bit is higher in level of importance than the second modulation symbol of a parity bit. Accordingly, by arranging the first modulation symbols close to the third modulation symbols as shown in FIG. 20, it is possible to use a highly accurate channel estimate for the important first modulation symbols.

On the other hand, when priority is given to the improvement in the overall channel estimation accuracy over the channel estimate used for the first modulation symbols, a part of the first modulation symbols are arranged apart from the third modulation symbols as shown in FIG. 21. This makes it possible to improve the channel estimation accuracy in the time direction, and consequently improve the overall channel estimation accuracy.

### Third Embodiment

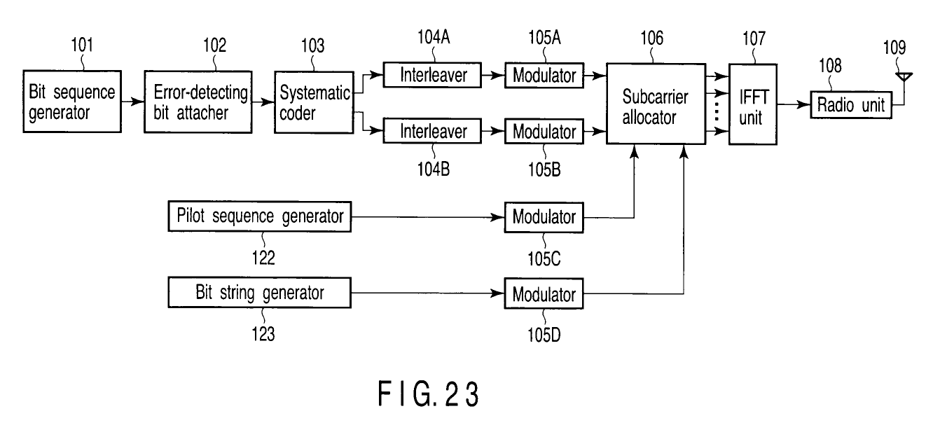

A third embodiment of the present invention will be described below with reference to FIGS. 23 to 31.

### <Radio Transmitting Apparatus>

As shown in FIG. 23, in a radio transmitting according to the third embodiment, one more bit sequence generator 123 and modulator 105D are added to the radio transmitting apparatus according to the second embodiment shown in FIG. 15.

While the above-mentioned bit sequence generator 101 generates a bit sequence used for control information such as a CCCH, the added bit sequence generator 123 generates, for example, a bit sequence corresponding to data to be originally transmitted. A bit sequence output from the bit sequence generator 101 is encoded by the systematic encoder 103 through the error-detecting bit attacher 102, and an information bit sequence and a parity bit sequence are generated. Here, the information bit sequence output from the systematic encoder 103 is called a first information bit sequence, and the information bit sequence generated by the bit sequence generator 123 is called a second information bit sequence.

The first information bit sequence is modulated by the added modulator 105D, and a fourth modulation symbol is generated. Like in the modulators 105A, 105B, and 105C, various digital modulation schemes known in the prior art, such as BPSK, QPSK, FSK, 16QAM, 64QAM, and the like are utilized in the modulator 105D.

The fourth modulation symbol is input to a subcarrier allocator 106, and is allocated to the fourth subcarriers allocated to the second information bit sequence. In this case, the first modulation symbols output from the modulator 105A are uniformly dispersed together with the third modulation symbols so as to be allocated to the first subcarriers. The second modulation symbols output from the modulator 105B are allocated to the second subcarriers of the subcarriers allocated to the first information bit sequence, and to which the first modulation symbols are not allocated. The fourth modulation symbols output from the modulator 105D are uniformly dispersed in at least one of the frequency direction and the time direction so as to be allocated to the fourth subcarriers allocated to the second information bit sequence.

The signal subjected to subcarrier allocation in the subcarrier allocator 106 is then subjected to OFDM modulation in the IFFT unit 107, and an OFDM signal is produced. The OFDM signal is upconverted in a radio unit 108 into a signal of a frequency in the RF band serving as a transmission RF signal. The transmission RF signal is further power-amplified, and is thereafter supplied to a transmitting antenna 109 so as to be transmitted.

### <Radio Receiving Apparatus>

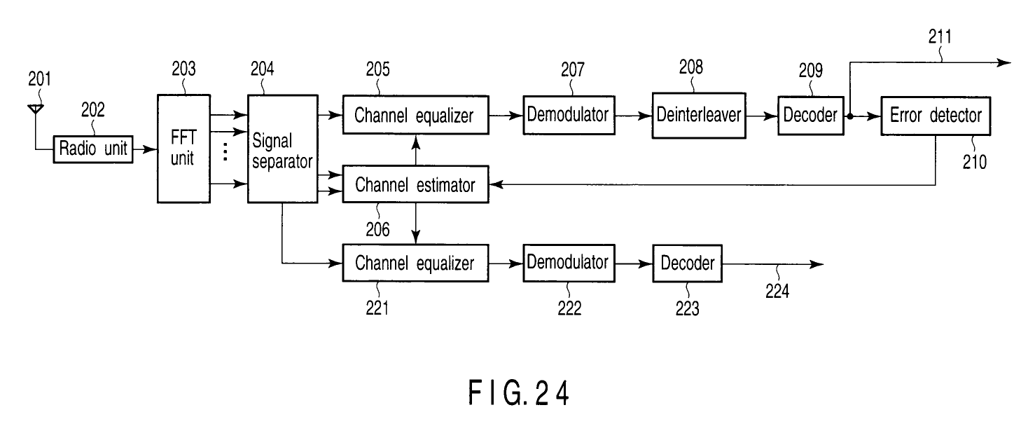

FIG. 24 shows a radio receiving apparatus corresponding to the radio transmitting apparatus shown in FIG. 23. When compared with the radio receiving apparatus according to the second embodiment shown in FIG. 16, the radio receiving apparatus according to the third embodiment differs from the radio receiving apparatus according to the second embodiment in the following point. That is, the first modulation symbol, second modulation symbol, third modulation symbol, and fourth modulation symbol are separated from a signal for each subcarrier output from an FFT unit 203 by a signal separator 204, and the fourth modulation symbol is input to a channel equalizer 221 which is newly added. In the channel equalizer 221, channel equalization of the fourth modulation symbol is performed. The fourth modulation symbol, after being subjected to the channel equalization, is demodulated by an added demodulator 222, and is further decoded by a decoder 223, whereby the second information bit sequence 224 is reproduced.

Here, the first information bit sequence and the second information bit sequence used in the third embodiment will be described below in detail. When the first information bit sequence is correctly received by the receiving apparatus, a first modulation symbol obtained by modulating the first information bit sequence is used for the channel estimation, and a calculated channel estimate is used for demodulation of the first information bit sequence and the second information bit sequence. That is, the receiving performance of the first information bit sequence affects the receiving performance of both the first information bit sequence and the second information bit sequence. Accordingly, it is desirable that the first information bit sequence be set lower in error rate than the second information bit sequence. For example, it is conceivable that the modulation scheme is changed to that having smaller error rate properties, the coding rate is lowered, or the power is enhanced.

In general, when data is to be transmitted, control information corresponding thereto is also simultaneously transmitted. In this case, in consideration of the importance of the information, it is desirable that the error rate properties of the control information be set low. In consideration of this relationship and the relationship between the first information bit sequence and the second information bit sequence, it is effective if the information (CCCH) for controlling the second information bit sequence is included in the first information bit sequence.

As described above, according to the third embodiment, the first modulation symbols corresponding to the first information bit sequence are dispersed in the frequency direction so as to be allocated to the first subcarriers, and the third modulation symbols corresponding to the pilot sequence usable for the channel estimation irrespective of the error detection result are uniformly dispersed in the frequency direction so as to be allocated to the third subcarriers. As a result, when DFE is performed in the receiving apparatus without performing re-encoding, channel estimation of high accuracy can be performed.

Further, by using a channel estimate obtained by using the first modulation symbols and the third modulation symbols for channel equalization of the fourth modulation symbols formed by modulating the second information bit sequence, the receiving performance of the second information bit sequence can also be improved. Furthermore, even when a burst error occurs, the burst error has practically no influence, and the randomness of the interleaving is improved, whereby the receiving performance is improved by the diversity effect, which is the same as the first and second embodiments.

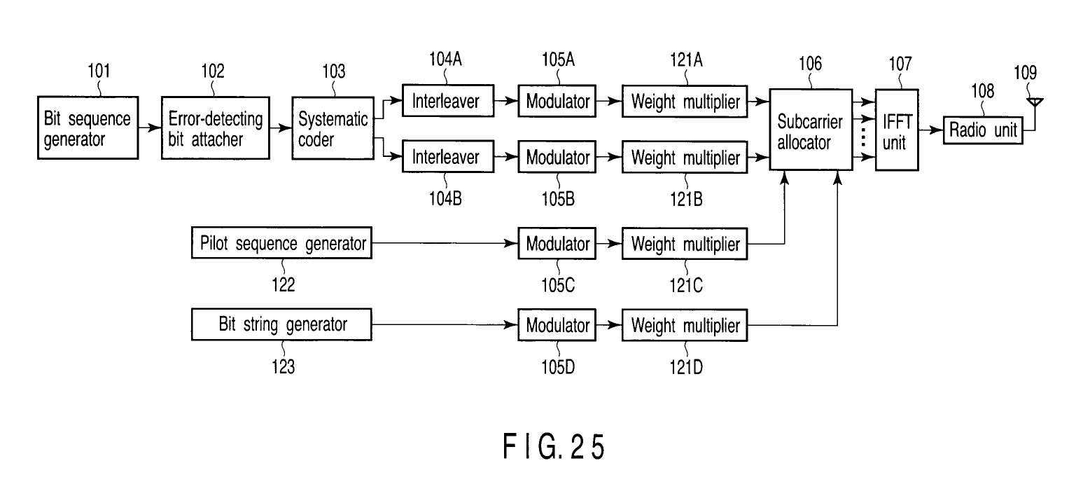

In the third embodiment too, weight multipliers 121A, 121B, 121C, and 121D may be inserted between each of the modulators 105A, 105B, 105C, and 105D and the subcarrier allocator 106 as shown in FIG. 25. In this case, when an absolute value of a weighting factor to be multiplied by the weight multiplier 121A, and an absolute value of a weighting factor to be multiplied by the weight multiplier 121C are made larger than an absolute value of a weighting factor to be multiplied by the weight multiplier 121B, and an absolute value of a weighting factor to be multiplied by the weight multiplier 121D, SNRs of the first modulation symbol and the third modulation symbol become relatively high as compared with the second modulation symbol, and the fourth modulation symbol, and hence it is possible to improve the accuracy of the channel estimation performed by using the first modulation symbol and the third modulation symbol.

### Examples of Subcarrier Allocation in the Third Embodiment

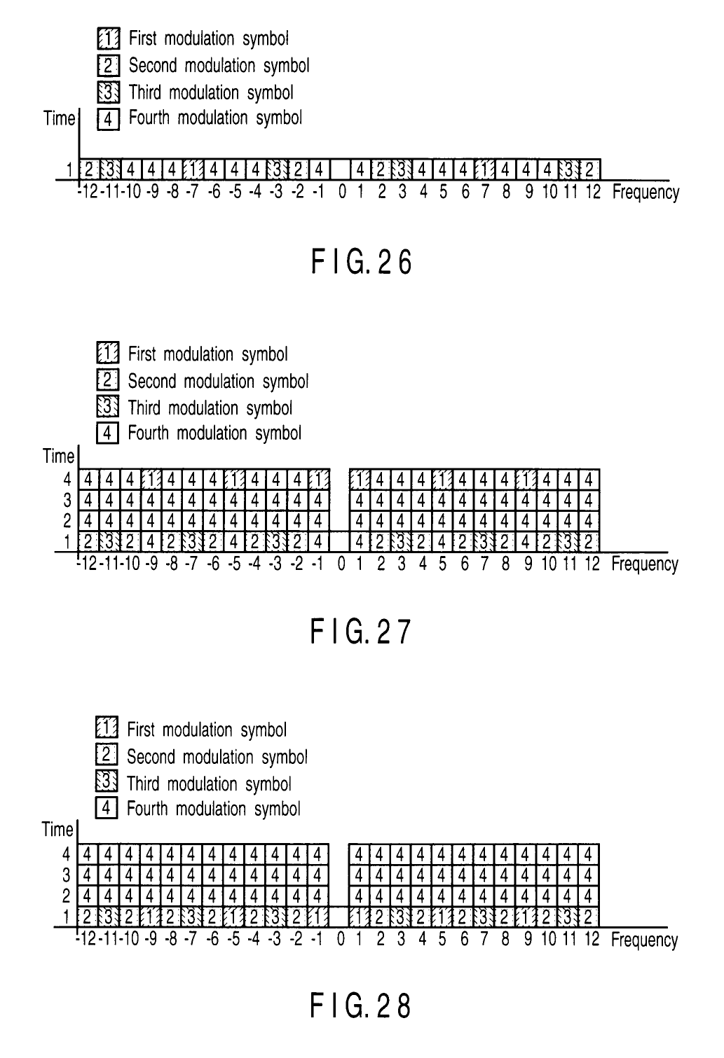

Examples of subcarrier allocation performed in the subcarrier allocator 106 in the third embodiment will be described below by using FIGS. 26 to 31. In the third embodiment, the first modulation symbols and the third modulation symbols are uniformly dispersed in the frequency direction and/or the time direction so as to be allocated to the subcarriers, whereby the accuraccy of the channel estimation is improved. In FIGS. 26 to 31, examples of subcarrier allocation are shown in which the abscissa is made the frequency axis, and the ordinate is made the time axis, like in FIGS. 5 to 14, and FIGS. 18 to 21.

### Examples of Subcarrier Allocation in the Third Embodiment

The operation of the subcarrier allocator in the third embodiment will be described below. In the third embodiment, like the second embodiment, both the first modulation symbols and the third modulation symbols are uniformly dispersed in the frequency direction and/or the time direction so as to be arranged, whereby the accuracy of the channel estimation is improved. In FIGS. 18 to 21, examples of subcarrier allocation are shown in which the abscissa is made the frequency axis, and the ordinate is made the time axis like in FIGS. 5 to 14.

FIG. 26 shows an example of subcarrier allocation of the case where the subcarriers to be allocated to the information bit sequence and the second bit sequence are limited to one OFDM symbol, and the coding rate is 1/3. In the example shown in FIG. 26, the third modulation symbols are arranged at certain regular third periods (in the example in FIG. 26, periods each corresponding to eight sampling points) in the frequency direction. The first modulation symbols are also arranged at the third periods, and are arranged at positions shifted from those of the third modulation symbols by half the first period (in the example in FIG. 26, a period corresponding to four sampling points) in the frequency direction.

When the first modulation symbols and the third modulation symbols are respectively allocated to the first subcarriers and the third subcarriers in the manner described above, both the first modulation symbols and the third modulation symbols are uniformly dispersed in the frequency direction, whereby it is possible to perform channel estimation of higher accuracy by using the first modulation symbols and the third modulation symbols.

Further, in the allocation shown in FIG. 26, the modulation symbols are arranged so as to be uniformly dispersed in the frequency direction even in terms of only the third modulation symbols, and hence when an error is detected in the information bit sequence, even if the channel estimation is performed by using only the third modulation symbols, it is possible to perform channel estimation of high accuracy.

Further, in the allocation shown in FIG. 26, the second modulation symbols are allocated to the second subcarriers so as to be close to the third modulation symbols. This makes it possible to subject the third modulation symbols to channel equalization by using a channel estimate of high accuracy, obtained by virtue of the second modulation symbols, and improve the receiving performance of the information bit sequence.

FIGS. 27 to 31 show examples of subcarrier allocation of a case where the first subcarriers allocated to the information bit sequence, and the second subcarriers allocated to the second bit sequence span a plurality of OFDM symbols. When the first modulation symbols and the third modulation symbols are uniformly dispersed in both the frequency direction and the time direction so as to be allocated to the first subcarriers, and the third subcarriers, respectively as shown in FIG. 27, it is possible to perform channel estimation excellent in accuracy in both the time direction and the frequency direction.

When the first modulation symbols and the third modulation symbols are uniformly dispersed in the frequency direction so as to be allocated to the first subcarriers, and the third subcarriers, respectively as shown in FIG. 28, it is possible to perform channel estimation excellent in accuracy in the frequency direction.

When the first modulation symbols and the third modulation symbols are uniformly dispersed in the time direction so as to be respectively allocated to the first subcarriers, and the third subcarriers, respectively as shown in FIG. 29, it is possible to perform channel estimation excellent in accuracy in the time direction.

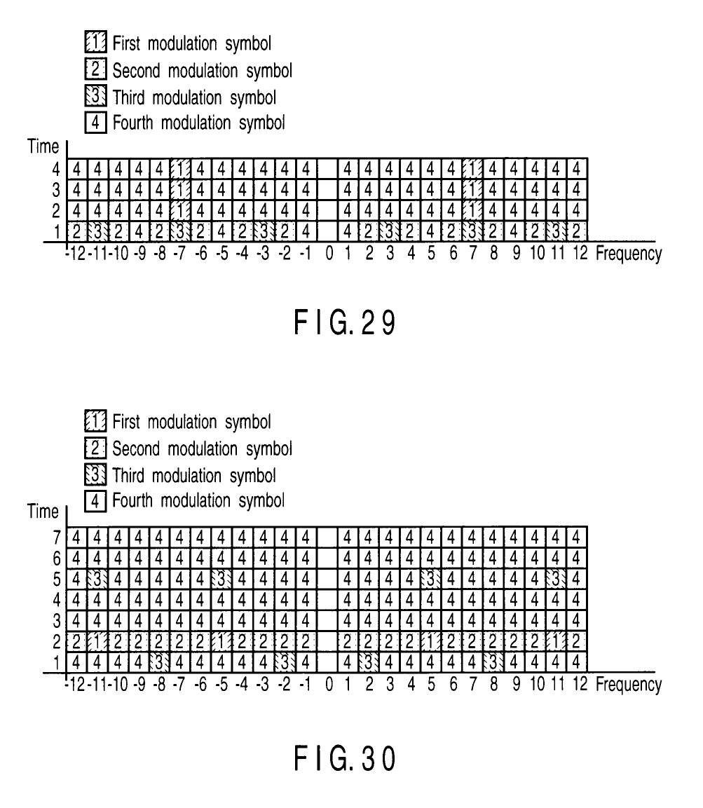

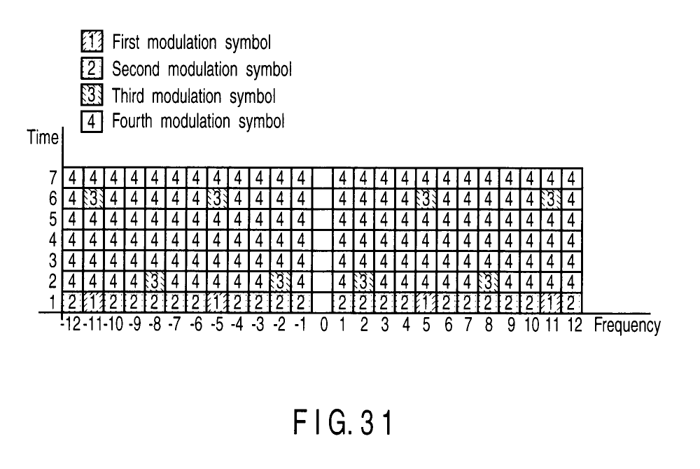

As shown in FIGS. 30 and 31, the third modulation symbols may be uniformly dispersed in both the frequency direction and the time direction so as to be allocated to the third subcarriers, and the first modulation symbols may be allocated to the first subcarriers such that the third modulation symbols are interpolated. This makes it possible to enhance not only the channel estimation accuracy in both the frequency direction and the time direction even in the channel estimation using the third modulation symbols, but also channel estimation accuracy in the channel estimation using the first modulation symbols.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A radio transmitting apparatus comprising:
an attacher to attach an error-detecting bit to a first bit sequence to be transmitted to produce a second bit sequence;
a coder to perform systematic coding on the second bit sequence to generate an information bit sequence and a parity bit sequence;
a first modulator to modulate the information bit sequence to generate a first modulation symbol;
a second modulator to modulate the parity bit sequence to generate a second modulation symbol;
an allocator configured to allocate the first modulation symbols to a plurality of first subcarriers by dispersing the first modulation symbols in at least one of the frequency direction and the time direction modulation symbol, and allocate the second modulation symbols to a plurality of second subcarriers different from the first subcarriers;
an OFDM modulator to perform orthogonal frequency division multiplexing (OFDM) modulation on the first modulation symbol and the second modulation symbol by using the first subcarriers and the second subcarriers to generate an OFDM signal; and
a transmitting unit configured to transmit the OFDM signal.

2. The apparatus according to claim 1, further comprising:
a first multiplier to multiply the first modulation symbol by a first weighting factor; and
a second multiplier to multiply the second modulation symbol by a second weighting factor having a smaller absolute value than an absolute value of the first weighting factor.

3. The apparatus according to claim 1, further comprising: a third modulator to modulate a pilot sequence to generate a third modulation symbol, wherein
the allocator is configured to further allocate the third modulation symbols to third subcarriers different from the first subcarriers and the second subcarriers by dispersing the third modulation symbols.

4. The apparatus according to claim 3, further comprising:
a first multiplier to multiply the first modulation symbol by a first weighting factor;
a second multiplier to multiply the second modulation symbol by a second weighting factor having a smaller absolute value than an absolute value of the first weighting factor; and
a third multiplier to multiply the third modulation symbol by a third weighting factor having a larger absolute value than the absolute value of the second weighting factor.

5. A radio transmitting apparatus comprising:
an attacher to attach an error-detecting bit to a first bit sequence to be transmitted to produce a second bit sequence;
a coder to perform systematic coding on the second bit sequence to generate a first information bit sequence and a parity bit sequence;
a first modulator to modulate the first information bit sequence to generate a first modulation symbol;
a second modulator to modulate the parity bit sequence to generate a second modulation symbol;
a third modulator to modulate a pilot sequence to generate a third modulation symbol;
a fourth modulator to a second information bit sequence to generate a fourth modulation symbol;
an allocator configured to allocate the first modulation symbols to first subcarriers dispersed in at least one of the frequency direction and the time direction, allocate the second modulation symbols to second subcarriers, allocate the third modulation symbols to third subcarriers dispersed together with the first subcarriers, in at least one of the frequency direction and the time direction, and allocate the fourth modulation symbols to fourth subcarriers;
an OFDM modulator to perform orthogonal frequency division multiplexing (OFDM) modulation on a plurality of symbols including the first modulation symbol, the second modulation symbol, the third modulation symbol, and the fourth modulation symbol to generate an OFDM signal; and
a transmitting unit configured to transmit the OFDM signal.

6. The apparatus according to claim 5, wherein
the coder and the first modulator are configured to perform the systematic coding and the modulation of the first information bit sequence, respectively to make an error rate of the first information bit sequence lower than an error rate of the second information bit sequence.

7. The apparatus according to claim 5, wherein
the first information bit sequence includes a signal for controlling the second information bit sequence.

8. The apparatus according to claim 5, further comprising:
a first multiplier to multiply the first modulation symbol by a first weighting factor;
a second multiplier to multiply the second modulation symbol by a second weighting factor having a smaller absolute value than an absolute value of the first weighting factor;
a third multiplier to multiply the third modulation symbol by a third weighting factor having a larger absolute value than the absolute value of the second weighting factor; and a fourth multiplier to multiply the fourth modulation symbol by a fourth weighting factor having a smaller absolute value than the absolute value of the first weighting factor.

9. A radio receiving apparatus comprising:
a receiving unit configured to receive an OFDM signal transmitted from the radio transmitting apparatus according to claim 1;
an OFDM demodulator to demodulate the OFDM signal to separate the demodulated signal into signals for each subcarrier;
a separator to separate the signals for each subcarrier into a first modulation symbol and a second modulation symbol;
an equalizer to perform channel equalization on each of the first modulation symbol and the second modulation symbol in accordance with a channel estimation value to obtain an equalized signal;
a demodulator to demodulate the equalized signal to generate a demodulated signal;
a decoder to decode the demodulated signal to obtain decoded data;
a detector to detect an error of the decoded data; and
an estimator to perform a channel estimation by using the first modulation symbol when no error is detected to obtain the channel estimation value.

10. The apparatus according to claim 9, wherein
the first modulation symbol is multiplied by a first weighting factor, and the second modulation symbol is multiplied by a second weighting factor having a smaller absolute value than an absolute value of the first weighting factor.

11. A radio receiving apparatus comprising: a receiving unit configured to receive an OFDM signal transmitted from the radio transmitting apparatus according to claim 3;
an OFDM demodulator to demodulate the OFDM signal to separate the received OFDM signal into signals for each subcarrier;
a separator to separate the signals for each subcarrier into a first modulation symbol, a second modulation symbol, and a third modulating symbol;
an equalizer to perform channel equalization to the first modulation symbol and the second modulation symbol in accordance with a channel estimation value to obtain an equalized signal;
a demodulator to demodulate each of the equalized signal to obtain a demodulated signal;
a decoder to decode the demodulated signal to obtain decoded data;
a detector to detect an error of the decoded data; and
an estimator to perform a channel estimation by using the first modulation symbol and the third modulation symbol if no error is detected, and perform the channel estimation by using the third modulation symbol if an error is detected.

12. The apparatus according to claim 11, wherein
the first modulation symbol is multiplied by a first weighting factor,
the second modulation symbol is multiplied by a second weighting factor having a smaller absolute value than an absolute value of the first weighting factor, and
the third modulation symbol is multiplied by a third weighting factor having a larger absolute value than the absolute value of the second weighting factor.

13. A radio receiving apparatus comprising:
a receiving unit configured to receive an OFDM signal transmitted from the radio transmitting apparatus according to claim 5;
an OFDM demodulator to demodulate the received OFDM signal to separate the received OFDM signal into signals for each subcarrier;
a separator to separate the signals for each subcarrier into a first modulation symbol, a second modulation symbol, a third modulating symbol, and a fourth modulation symbol;
a first equalizer to perform channel equalization each of the separated first modulation symbol and the second modulation symbol in accordance with a channel estimation value, to obtain a first equalized signal;
a first demodulator to demodulate the first equalized signal to obtain a first demodulated signal;
a decoder to decode the first demodulated signal to obtain decoded data;
a detector to detect an error of the decoded data;
a second equalizer to perform channel equalization to the fourth modulation symbol in accordance with the channel estimate to obtain a second equalized signal;
a second demodulator to demodulate the second equalized signal to obtain a second demodulated signal; and
an estimator to perform a channel estimation, in order to obtain a channel estimate, perform a channel estimation by using the first modulation symbol and the third modulation symbol if no error is detected, and perform a channel estimation by using the third modulation symbol if an error is detected.

14. The apparatus according to claim 13, wherein
the first modulation symbol is multiplied by a first weighting factor,
the second modulation symbol is multiplied by a second weighting factor having a smaller absolute value than an absolute value of the first weighting factor,
the third modulation symbol is multiplied by a third weighting factor having a larger absolute value than the absolute value of the second weighting factor, and
the fourth modulation symbol is multiplied by a fourth weighting factor having a smaller absolute value than the absolute value of the first weighting factor.
